(19) United States
(12) Patent Application Publication
(10) Pub. No.: US 2018/0323614 A1
(43) Pub. Date: Nov. 8, 2018

(54) APPARATUS CONTROL DEVICE, APPARATUS CONTROL SYSTEM, AND APPARATUS CONTROL METHOD

(71) Applicant: SHARP KABUSHIKI KAISHA, Sakai City, Osaka (JP)

(72) Inventor: ATARU OKURA, Sakai City (JP)

(21) Appl. No.: 15/774,239

(22) PCT Filed: Nov. 7, 2016
(86) PCT No.: PCT/JP2016/082995

§ 371 Date: May 7, 2018

(30) Foreign Application Priority Data
Nov. 13, 2015 (JP) 2015-222856
Nov. 13, 2015 (JP) 2015-222857

(51) Int. Cl. H02J 3/32; H02J 7/35; H02J 3/38; H02J 7/00; H02M 7/66

(52) U.S. Cl. CPC H02J 3/32; H02J 7/35; H02M 7/66; H02J 7/0032; H02J 3/383

(57) ABSTRACT

An apparatus control system includes: a switching unit (103) disposed in an air conditioner outdoor unit (101) operating on DC power fed from a storage battery and AC power fed from an AC power source including a power system grid, the switching unit (103) being configured to switch a power feed to the air conditioner outdoor unit (101) between the DC power and the AC power; and a switching control unit (105) configured to determine whether or not the storage battery is discharging and accordingly switch the switching unit (103).

### TECHNICAL FIELD

The present invention relates to apparatus control devices, systems, and methods for controlling an apparatus operating switchably on AC power and DC power stored in a storage battery.

### BACKGROUND ART

A technology is known that reduces energy conversion loss that occurs when the DC power generated by solar cells is converted first to AC power and then back to DC power before consumed by a device (see, for example, Patent Literature 1).

Patent Literature 1 discloses an electric power system that connects DC electric power from solar cells to an AC commercial power system via an inverter and also connects an output end of the inverter to a DC load via a rectifier circuit. An input end of the inverter is coupled to an output end of the rectifier circuit via a DC line to feed DC electric power from solar cells directly to the DC load through the DC line.

### CITATION LIST

### Patent Literature

Patent Literature 1: Japanese Unexamined Patent Application Publication, Tokukaihei, No. 6-165395

### SUMMARY OF INVENTION

### Technical Problem

According to Patent Literature 1, when the solar cells generate sufficient power, the power generated by the solar cells is fed to an apparatus. On the other hand, when the solar cells generate electric power that is insufficient to operate the apparatus, AC power is fed to the apparatus after being rectified.

Meanwhile, many houses are equipped with a storage battery as well as solar cells. Accordingly, the electric power stored in the storage battery is sometimes fed to more than one apparatus. In some cases, an electricity tariff system is employed in which the use of solar cells and storage batteries is taken into account.

In such situations, if a system is configured by connecting a storage battery to an apparatus in the same manner as in the case with the solar cells of Patent Literature 1 for the purpose of reduced loss in the conversion of DC power stored in the storage battery, the electric power stored in the storage battery is preferentially supplied to the apparatus until the storage battery discharges to a specified level. This may not always be an efficient way of using power.

In other words, there have been no proposals for a system in which an apparatus is efficiently used that is capable of operating on both AC power and DC power from a storage battery.

The present invention has been made in view of these problems. It is an object of the present invention to efficiently use an apparatus capable of operating on AC power and DC power stored in a storage battery.

### Solution to Problem

To solve the problems, the present invention, in one aspect thereof, is directed to an apparatus control device including: a switching circuit disposed inside or outside an electric apparatus operating on DC power fed from a DC power source and AC power fed from an AC power source including a power system grid, the switching circuit being configured to switch a power feed to the electric apparatus between the DC power and the AC power; and a controller configured to determine whether or not the DC power source is discharging and accordingly switch the switching circuit.

To solve the problems, the present invention, in another aspect thereof, is directed to an apparatus control method of operating a switching circuit disposed inside or outside an electric apparatus operating on DC power fed from a DC power source and AC power fed from an AC power source including a power system grid, the switching circuit being configured to switch a power feed to the electric apparatus between the DC power and the AC power, the method including: determining whether or not the DC power source is discharging; and accordingly switching the switching circuit.

### Advantageous Effects of Invention

The present invention results in the advantage of being able to efficiently use an apparatus capable of operating on AC power and DC power stored in a storage battery.

### BRIEF DESCRIPTION OF DRAWINGS

FIG. 1 is a schematic illustration of an apparatus control system in accordance with a first embodiment.

FIG. 2 is a block diagram of an air conditioner outdoor unit for use in the first embodiment, the air conditioner outdoor unit switchably operating on DC power from a storage battery and AC power from a power system grid.

FIG. 3 is a block diagram of another configuration of the air conditioner outdoor unit in which the switching unit shown in FIG. 2 is disposed outside the air conditioner outdoor unit.

FIG. 4 is a flow chart depicting an operation of the apparatus control system in accordance with the first embodiment.

FIG. 5 is a flow chart depicting an operation of an apparatus control system in accordance with a second embodiment.

FIG. 6 is a flow chart depicting an operation of an apparatus control system in accordance with a third embodiment.

FIG. 7 is a flow chart depicting an operation of an apparatus control system in accordance with a fourth embodiment.

FIG. 8 is a flow chart depicting an operation of an apparatus control system in accordance with a fifth embodiment.

FIG. 9 is a schematic illustration of an apparatus control system in accordance with a sixth embodiment.

FIG. 10 is a flow chart depicting an operation of the apparatus control system in accordance with the sixth embodiment.

FIG. 11 is a flow chart depicting an operation of an apparatus control system in accordance with a seventh embodiment.

FIG. 12 is a flow chart depicting an operation of an apparatus control system in accordance with an eighth embodiment.

### DESCRIPTION OF EMBODIMENTS

The following will describe embodiments of the present invention in reference to drawings.

### First Embodiment

### System Configuration

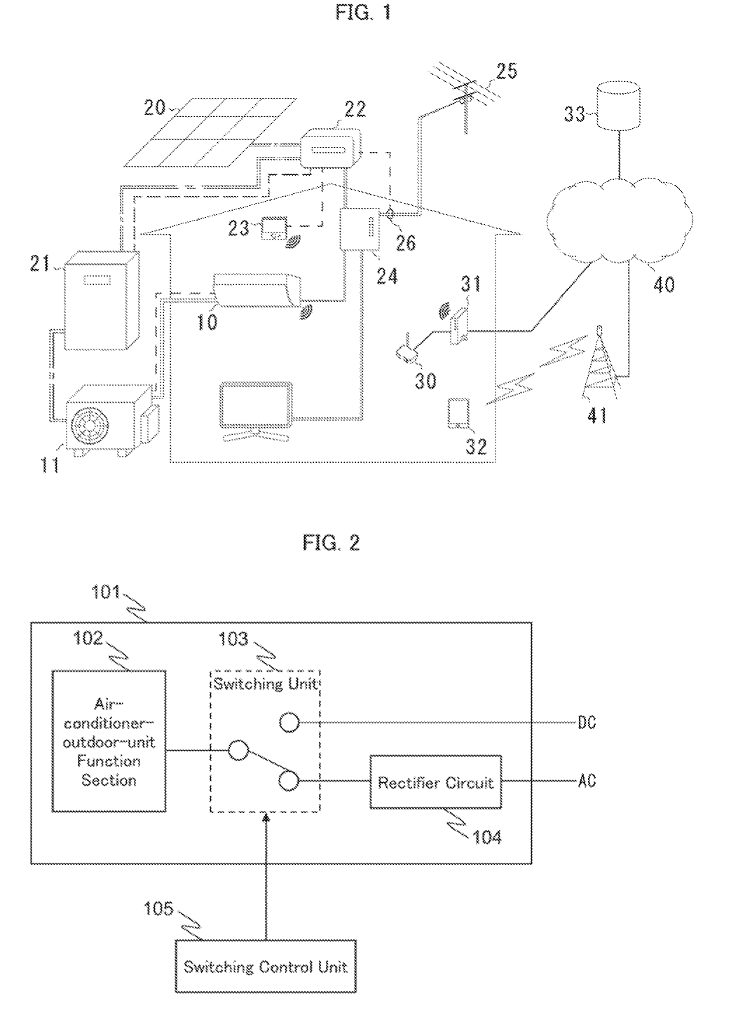

FIG. 1 is a schematic illustration of an apparatus control system in accordance with a first embodiment.

The apparatus control system shown in FIG. 1 includes home electrical appliances, a power conditioner 22, an electric power monitor 23, a home energy management system (HEMS) controller 30, and a router 31. The home electrical appliances include among others an air conditioner indoor unit 10, an air conditioner outdoor unit (electric apparatus) 11, and a television. The power conditioner 22 is connected to a storage battery (DC power source) 21. The electric power monitor 23 may acquire information from the power conditioner 22 to produce a display. The HEMS controller 30 may transmit remote control signals to the air conditioner indoor unit 10. The router 31 is connected to the HEMS controller 30 via an Ethernet® cable.

Of the home electrical appliances, the air conditioner indoor unit 10 and the air conditioner outdoor unit 11 together make up what is generally called an air conditioner. An “air conditioner” includes both the air conditioner indoor unit 10 and the air conditioner outdoor unit 11 throughout the present embodiment unless otherwise stated. The air conditioner indoor unit 10 operates on AC power fed from a power distribution board 24 in the present embodiment. On the other hand, the air conditioner outdoor unit 11 may selectively operate on DC power fed from the storage battery 21 or AC power fed via the air conditioner indoor unit 10. To put it differently, the air conditioner outdoor unit 11 is an electric apparatus that operates on DC power fed from the storage battery 21 serving as a DC power source and AC power fed from an AC power source including a power system grid (power system grid) 25. The electric power feed to the air conditioner outdoor unit 11 is switchable by a switching circuit disposed inside or outside the air conditioner outdoor unit 11. Further details of the air conditioner outdoor unit 11 will be given later. The air conditioner indoor unit 10 has a wireless LAN communications function to communicate with the HEMS controller 30 via the router 31 which has a wireless LAN function.

The power conditioner 22 is connected to solar cells (solar panels) 20 and the storage battery 21. The power conditioner 22 has functions including a function of storing the DC power generated by the solar cells 20 in the storage battery 21, a function of converting the DC power generated by the solar cells 20 and the electric power stored in the storage battery 21 to AC power and supplying the resultant AC power to loads (home electrical appliances) or back to the power system grid 25 (“reverse power flow” or “power export”), and a function of converting the AC power fed from the power system grid 25 to DC power and storing the resultant DC power in the storage battery 21. The power conditioner 22 also monitors, using a sensor 26, the main electric power of a house where the apparatus control system of the present embodiment is installed, and acquires information related to the direction and value of an electric current. The power conditioner 22 knows through this arrangement whether electric power is being bought from the power system grid 25 (“electric power buying state”) or fed back (exported) to the power system grid 25 (“electric power selling state”). The power conditioner 22 has additional functions of measuring the electric power generated by the solar cells 20 and acquiring information on charged capacity of the storage battery 21 from the storage battery 21.

The electric power monitor 23 has functions including a function of communicating with a display unit, a user operation receiving unit, and the power conditioner 22, so that the user can see the information acquired by the power conditioner 22 on the electric power monitor 23. The electric power monitor 23 may further receive inputs from the user so that the user can control operation of, for example, the power conditioner 22. The electric power monitor 23 has a wireless LAN communications function to operate in concert with an external apparatus through wireless control instructions that are in compliance with, for example, ECHONET Lite®.

The HEMS controller 30 is a control device that transmits ECHONET Lite-compliant control instructions to an apparatus to be controlled (air conditioner indoor unit 10 in the present embodiment). The HEMS controller 30 may transmit control instructions when the HEMS controller 30 has determined to do so or may alternatively relay control instructions transmitted from a server. In this situation, the control instructions from the HEMS controller 30 are transmitted via the router 31 to an apparatus to be controlled.

The HEMS controller 30 has a function of measuring the power consumption of each home electrical appliance with electric power measuring instruments (not shown) provided to the individual home electrical appliances and transmitting information related to the power consumption measurements to a server 33. This arrangement enables the user to browse, using a mobile terminal 32, through information related to the power consumption of the home electrical appliances that is stored in the server 33. The HEMS controller 30 may operate in concert with the electric power monitor 23 through ECHONET Lite-compliant control instructions.

The router 31 is a general router and has a function of providing connection to the Internet 40. The router 31 has an IEEE 802.11 wireless local area network (LAN) function and communicates with the air conditioner indoor unit 10 over a wireless LAN. Meanwhile, the router 31 is connected to the HEMS controller 30 via an Ethernet® cable.

The mobile terminal 32 is typically a smartphone on which applications for remote control and browsing through the information related to the power consumption measurements may be provided so that they can run on a general Web browser on the mobile terminal 32 upon accessing the server 33. Alternatively, the applications may be of a dedicated type. The user can utilize this remote monitoring system upon entering a user ID and password given to the user on the mobile terminal 32. Because the mobile terminal 32 and the server 33 communicate with each other over a public telephone network 41 and the Internet 40, the user can control the apparatus control system even when out of home. When the user is at home, the mobile terminal 32 and the server 33 may communicate over a wireless LAN via the router 31.

The server 33 includes an interface for communications with the HEMS controller 30 and has a function of, when control instructions to a home electrical appliance to be controlled are received from the mobile terminal, transmitting the control instructions to the HEMS controller 30. The server 33 has another function of receiving and storing information on electric power and cumulative electric power that is transmitted from the HEMS controller 30. The server 33 has another interface for communications with the mobile terminal 32 to provide the mobile terminal 32 with this information upon request from the mobile terminal 32.

In the present embodiment, the single server 33 provides for the functions described above. Alternatively, there may be provided separate servers in a communicable manner, one having functions involving the HEMS controller 30 such as a function of remotely controlling home electrical appliances and a function of receiving incoming information on electric power and cumulative electric power and another for providing Web browser-based applications to the mobile terminal 32.

### Configuration of Apparatus Control Device

FIG. 2 is a block diagram of an air conditioner outdoor unit 101 for use in the present embodiment, the air conditioner outdoor unit 101 switchably operating on DC power from the storage battery 21 and AC power from the power system grid 25. The air conditioner outdoor unit 101 of the present embodiment corresponds to the air conditioner outdoor unit 11 in FIG. 1. An apparatus control device of the present embodiment includes a switching unit (switching circuit) 103 and a switching control unit (controller) 105.

An air-conditioner-outdoor-unit function section 102 is a section that functions as a general air conditioner outdoor unit, but differs from one in that the air-conditioner-outdoor-unit function section 102 has another function of receiving control instructions for switching the switching unit 103. This function is missing from general air conditioner outdoor units. In other words, the air conditioner outdoor unit 101 of the present embodiment switches the switching unit 103 on the basis of control instructions from the external switching control unit 105. This arrangement enables the air conditioner outdoor unit 101 to switch, for its operating power, between the DC power discharged from the external storage battery 21 and the DC power obtained by conversion by a rectifier circuit 104 of the AC power fed, for example, from the air conditioner indoor unit 10.

The air conditioner outdoor unit 101 is configured such that it can operate on both AC and DC power. The AC power from the power system grid 25 is fed via the air conditioner indoor unit 10 to the air conditioner outdoor unit 101 where the AC power is converted to DC by the rectifier circuit 104 and coupled to one of two input terminals of the switching unit 103. The other input terminal of the switching unit 103 is connected to the storage battery 21 so that the DC power stored in the storage battery 21 is coupled as is to that input terminal. The switching unit 103 outputs one of these electric power inputs to the air-conditioner-outdoor-unit function section 102 on the basis of an instruction from the switching control unit 105. FIG. 2 shows the switching control unit disposed outside the air conditioner outdoor unit 101; alternatively, the switching control unit may be disposed inside the air conditioner outdoor unit 101. As a further alternative, the switching unit 103 and the rectifier circuit 104 may be disposed outside the air conditioner outdoor unit 101 as will be described later in detail. For example, the rectifier circuit 104 may be disposed in the air conditioner indoor unit 10 so that the air conditioner indoor unit 10 can supply a direct current.

As an example, in the present embodiment, the switching control unit 105 is disposed inside the air conditioner indoor unit 10 shown in FIG. 1 and configured to receive control signals from the HEMS controller 30 over a wireless LAN and to transmit switching control signals to the switching unit 103 in the air conditioner outdoor unit 101 by wired communications on the basis of these control signals. In addition, the HEMS controller 30, which is a control unit for the entire system, is provided separately from the switching control unit 105. Alternatively, the HEMS controller 30 and the switching control unit 105 may be integrated.

When the air conditioner outdoor unit is powered by a storage battery, a conventional air conditioner outdoor unit converts electric power from the storage battery to AC power using a power conditioner, and this AC power is converted back to DC power using a rectifier circuit provided in the outdoor unit before actually consumed. Conversion loss is therefore inevitable. In contrast, the air conditioner outdoor unit 101 of the present embodiment operates on the DC power from the storage battery 21 without needing any conversion. Therefore, the air conditioner outdoor unit 101 may reduce such conversion loss.

FIG. 3 is a block diagram of another configuration of the air conditioner outdoor unit 101 in which the switching unit 103 shown in FIG. 2 is disposed outside the air conditioner outdoor unit 101. The air conditioner outdoor unit 101 shown in FIG. 3 is controlled using an apparatus control device in the same manner as the air conditioner outdoor unit 101 shown in FIG. 2 is controlled, except that the switching unit 103 and the rectifier circuit 104 are disposed outside the air conditioner outdoor unit 101. Specifically, the air conditioner outdoor unit 101 may switch, for its operating power, between the DC power discharged from the external storage battery 21 and the DC power obtained by conversion by the rectifier circuit 104 of the AC power fed, for example, from the air conditioner indoor unit 10.

### Electricity Tariff System

Next will be described an electricity tariff system adopted in the present embodiment. Since the present embodiment allows electricity to be stored in the storage battery 21, the user can enjoy economic benefits by storing electric power in the storage battery 21 when the electricity tariff system offers a low unit price and consuming the electric power stored in the storage battery 21 when the electricity tariff system offers a high unit price. One of tariff systems available for a general household is suitable for use of the storage battery 21 and offers an inexpensive night electricity tariff. In this tariff system, for example, the user is charged 11 yen/kwh in a first time period of 23:00 to 7:00, 25 yen/kwh in each second time period of 7:00 to 10:00 and 17:00 to 23:00, and 33 yen/kwh in a third time period of 10:00 to 17:00. For the user who has the storage battery 21 in place to enjoy economic benefits with such an electricity tariff system, it is only required that the user fully charge the storage battery 21 in the first time period, cover electric power consumption in the third time period as much as possible with the electric power stored in the storage battery 21, and if the storage battery 21 can discharge more than consumption over the third time period, feed from the storage battery 21 also in the second time period for consumption.

### Boost Effect

A general household where the solar cells 20 are installed is permitted to export electric power for a price if the solar cells 20 generate more electric power than the household can consume (“excess electric power”). A general household where the storage battery 21 is installed in addition to the solar cells 20 can, when installing the storage battery 21, choose any one of the two following options regarding unit selling prices of electric power.

A first option is commonly called a “no-boost effect” option. In this option, the storage battery 21 is prohibited from supplying electric power to loads while the solar cells 20 are generating excess electric power with some electric power being sold. Therefore, the exported electric power (reverse power flow) is equal to the excess electric power which is a difference obtained by subtracting the power consumption of the household from the electric power generated by solar power. The first option places such a household under the same conditions as a household where there is installed only a solar power generation device (including the solar cells 20 and the power conditioner 22), with no storage battery 21. The former household thus sells electric power at the same unit selling price as the latter household.

A second option is commonly called a “boost effect” option. In this option, the storage battery 21 is allowed to supply electric power to power-consuming apparatus while the solar cells 20 are generating excess electric power with some electric power being sold. It is possible to sell all the electric power generated by the solar cells 20 if the power-consuming apparatus is all powered by the storage battery 21 alone. Therefore, when compared to the first option, more of the electric power generated by the solar cells 20 can be sold. For this reason, the unit selling price of electric power in the second option is set lower than the unit selling price in the first, no-boost effect option.

### How to Control the System

The present embodiment will now describe a method of controlling an apparatus control system for a household that has chosen the no-boost effect option in the tariff system described above.

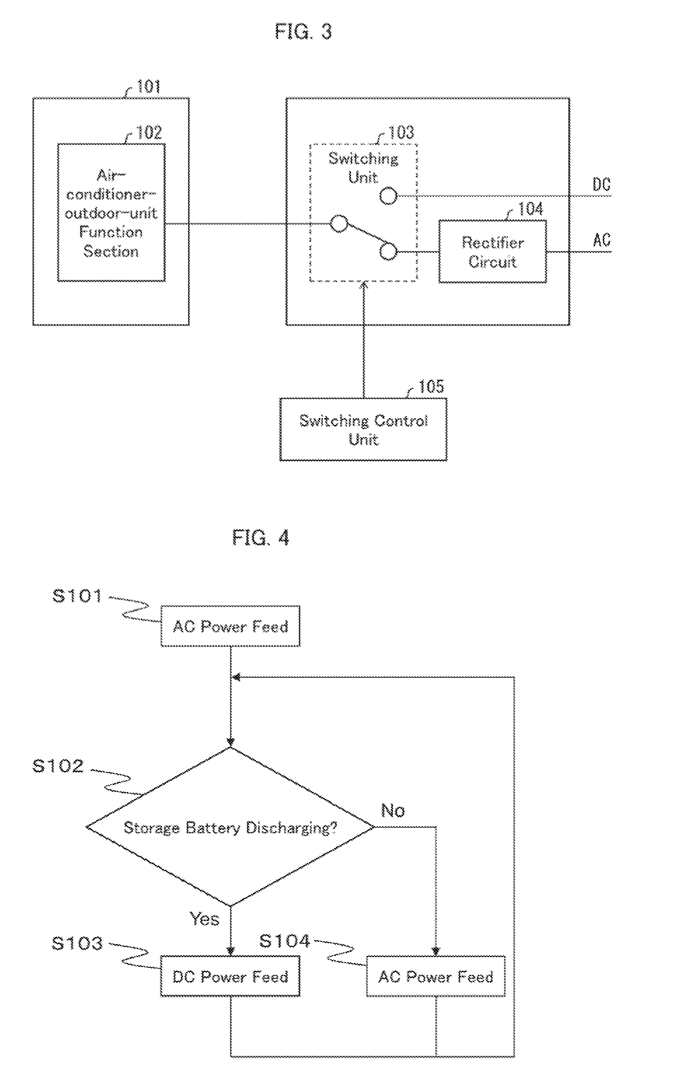

One sunny summer day is taken as a model case, which will be described below in reference to FIGS. 1, 2, and 4. The air conditioner is continuously switched on in this model case. FIG. 4 is a flow chart depicting an operation of the apparatus control system of the present embodiment.

The air conditioner outdoor unit 11 is operating on AC in the first time period (S101).

In the present embodiment, the power conditioner 22 is continuously monitoring whether the household is buying electric power from the main or selling (exporting) electric power to the main, by using the sensor 26. The storage battery 21 is controlled to charge/discharge based on this information. Specifically, upon detection by the sensor 26 of power export (reverse power flow) while the solar cells 20 are generating electric power, the power conditioner 22 immediately controls the storage battery 21 to stop discharging. This control ensures that the system of the present embodiment does not make use of boost effect.

Either the power conditioner 22 or the electric power monitor 23, which controls the power conditioner 22 by means of instructions, possesses information on the time periods specified in the tariff system to control charging/discharging of the storage battery 21 in accordance with the time periods.

Charged in the first time period, the storage battery 21 is full at 7:00 in the morning. Assume that the storage battery 21 has a sufficient capacity to supply the electric power required in the present embodiment. At 7:00 when the first time period ends and the second time period starts, the unit electricity price rises. The air conditioner is therefore operated at a lower unit electricity price if it is powered by the storage battery 21 than by the power system grid 25. Hence, the power conditioner 22 starts discharging the storage battery 21 to supply the electric power stored in the storage battery 21 to loads.

Upon acquiring information from the power conditioner 22 that the storage battery 21 has started discharging (“Yes” in step S102), the HEMS controller 30 transmits to the switching control unit 105 a signal representative of a permission to supply DC power. The switching control unit 105, in response to receiving this signal, switches the switching unit 103 to a DC power feed (S103). Starting at this moment, the DC electric power stored in the storage battery 21 is fed as is to the air conditioner outdoor unit 11.

No controlling action is made until 9:00 when the solar cells 20 generate more electric power in accordance with increasing insolation whereas power consumption decreases because the family uses less of the home electrical appliances in preparing themselves for the day. Accordingly, the household buys less electric power from the power system grid 25, and excess electric power is generated, a situation that could potentially lead to electric power export (reverse power flow).

However, immediately upon detection by the sensor 26 of power export, the power conditioner 22 stops discharging the storage battery 21 to inhibit boost effect.

The HEMS controller 30 continuously acquires information as to whether the storage battery 21 is charging or discharging, and upon acquiring information from the power conditioner 22 that the storage battery 21 has stopped discharging (“No” in step S102), transmits to the switching control unit 105 a signal representative of a prohibition of supplying DC power. The switching control unit 105, in response to receiving this signal, switches the switching unit 103 to an AC power feed (S104). Starting at this moment, AC power is fed to the air conditioner outdoor unit 11 from the power system grid 25.

No controlling action is made until 16:00 when the solar cells 20 generate less electric power in accordance with decreasing insolation whereas power consumption increases because the family uses more of the home electrical appliances in preparing for the evening time. Accordingly, electric power export decreases, which could potentially trigger electric power purchase from the grid. However, upon detecting a transition from the electric power selling state to the electric power buying state, the power conditioner 22 starts discharging the storage battery 21.

The HEMS controller 30, upon acquiring information from the power conditioner 22 that the storage battery 21 has started discharging (“Yes” in step S102), transmits to the switching control unit 105 a signal representative of a permission to supply DC power. The switching control unit 105, in response to receiving this signal, switches the switching unit 103 to a DC power feed (S103). Starting at this moment, the DC electric power stored in the storage battery is fed as is to the air conditioner outdoor unit 11.

As described so far, the HEMS controller 30 is configured to permit a DC power feed only while the storage battery 21 is discharging. Therefore, in a system in which the power conditioner 22 controls the storage battery 21 properly to inhibit boost effect, the HEMS controller 30 may implement control that is simple, but still unfailingly inhibits boost effect, based on whether or not the storage battery 21 is discharging.

No controlling action is made until 23:00 when the first time period starts and the unit price of the electric power stored in the storage battery 21 becomes equal to the unit price of the electric power being bought from the power system grid 25. Because electric power needs to be stored in the storage battery 21 for use in the second and third time periods of a next day, the power conditioner 22 stops discharging the storage battery 21.

Upon acquiring information from the power conditioner 22 that the storage battery 21 has stopped discharging (“No” in step S102), the HEMS controller 30 transmits to the switching control unit 105 a signal representative of a prohibition of supplying DC power. The switching control unit 105, in response to receiving this signal, switches the switching unit 103 to an AC power feed (S104). Starting at this moment, AC power is fed to the air conditioner outdoor unit 11 from the power system grid 25.

The same control is repeated the next day.

By performing the control described above, an air conditioner capable of switchably operating on DC power from the storage battery 21 and AC power from the power system grid 25 may be used in a manner suitable to the electricity tariff system and the excess electric power purchase system.

In addition, since the DC power from the storage battery 21 is used as is to power the apparatus, there may be fewer DC/AC and AC/DC conversions involved. The electric power stored in the storage battery 21 may hence be used more efficiently.

In the present embodiment, the HEMS controller 30 acquires necessary information from the power conditioner 22. Alternatively, the HEMS controller 30 may be informed by the power conditioner 22 every time there is a change in the charging/discharging state of the storage battery 21.

As a further alternative, the HEMS controller 30 may acquire the same information from the electric power monitor 23 instead of from the power conditioner 22 if the electric power monitor 23 is in constant communication with the power conditioner 22.

In the present embodiment, the HEMS controller 30 has been described as playing a central role in the above-described control. It will be appreciated that alternatively, the server 33 may play a central role in the control instead of the HEMS controller 30.

### Second Embodiment

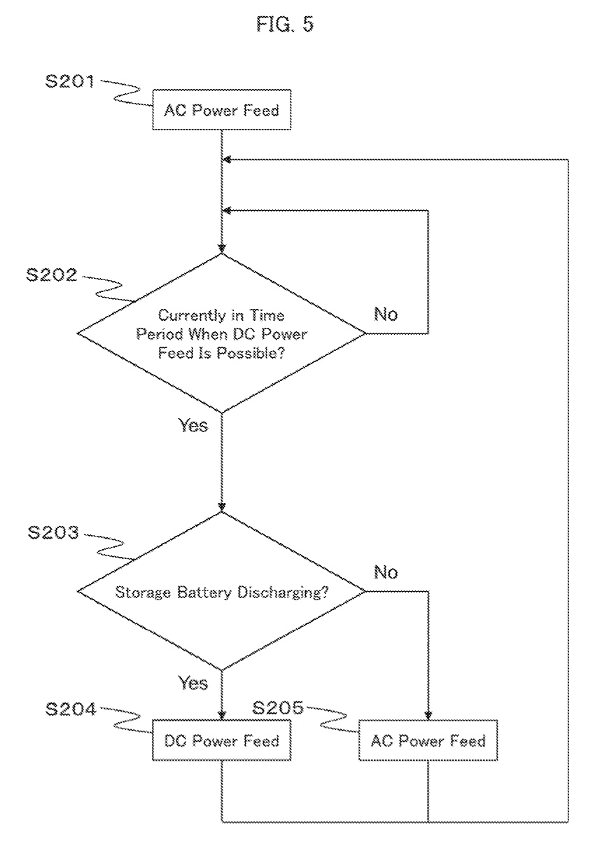

The present embodiment has the same basic configuration as the first embodiment. Referring to FIGS. 1, 2 and 5, the present embodiment will describe a method of controlling an apparatus control system for a household that has chosen the no-boost effect option in the same tariff system as the one described in the first embodiment. FIG. 5 is a flow chart depicting an operation in accordance with the present embodiment.

Note that for convenience of description, members of the present embodiment that have the same function as members of the previous embodiment are indicated by the same reference numerals, and description thereof is omitted.

In the first embodiment, either the power conditioner 22 or the electric power monitor 23, which controls the power conditioner 22 by means of instructions, possesses information on the time periods specified in the tariff system to control charging/discharging of the storage battery 21 in accordance with the time periods.

In contrast, in the present embodiment, neither the power conditioner 22 nor the electric power monitor 23 possesses such information. The power conditioner 22 or the electric power monitor 23 has a simple function of controlling charging/discharging of the storage battery 21.

Therefore, in the present embodiment, the HEMS controller 30 possesses information on the time periods specified in the tariff system and is configured to instruct the power conditioner 22 to control charging/discharging of the storage battery 21 in accordance with the time periods.

However, upon detection by the sensor 26 of power export while the solar cells 20 are generating electric power, the power conditioner 22 immediately stops discharging the storage battery 21 even if the power conditioner 22 is being instructed by the HEMS controller 30 to discharge the storage battery 21. The power conditioner 22 thus controls to inhibit boost effect even under an instruction from the HEMS controller 30 to discharge the storage battery 21.

Charged in the first time period, the storage battery 21 is full at 7:00 in the morning. Assume that the storage battery 21 has a sufficient capacity to supply the electric power required in the present embodiment. At 7:00 when the first time period ends and the second time period starts, the unit electricity price rises. The air conditioner is therefore operated at a lower unit electricity price if it is powered by the storage battery 21 than by the power system grid 25. Hence, in response to an instruction from the HEMS controller 30, the power conditioner 22 starts discharging the storage battery 21 to supply the electric power stored in the storage battery 21 to loads.

The HEMS controller 30 determines that the first time period has ended (“Yes” in step S202) and then acquires information as to whether the storage battery 21 is discharging. If the acquired information indicates that the storage battery 21 is discharging (“Yes” in step S203), the HEMS controller 30 transmits to the switching control unit 105 a signal representative of a permission to supply DC power. The switching control unit 105, in response to receiving this signal, switches the switching unit 103 to a DC power feed (S204). Starting at this moment, the DC electric power stored in the storage battery 21 is fed as is to the air conditioner outdoor unit 11.

No controlling action is made until 9:00 when the solar cells 20 generate more electric power in accordance with increasing insolation whereas power consumption decreases because the family uses less of the home electrical appliances in preparing themselves for the day. Accordingly, the household buys less electric power from the grid, and excess electric power is generated, a situation that could potentially lead to electric power export.

However, immediately upon detection by the sensor 26 of power export, the power conditioner 22 stops discharging the storage battery 21 to inhibit boost effect.

The HEMS controller 30 continuously acquires information as to whether the storage battery 21 is charging or discharging, and upon acquiring information from the power conditioner 22 that the storage battery 21 has stopped discharging (“No” in step S203), transmits to the switching control unit 105 a signal representative of a prohibition of supplying DC power. The switching control unit 105, in response to receiving this signal, switches the switching unit 103 to an AC power feed (S205). Starting at this moment, AC power is fed to the air conditioner outdoor unit 11 from the power system grid 25.

No controlling action is made until 16:00 when the solar cells 20 generate less electric power in accordance with decreasing insolation whereas power consumption increases because the family uses more of the home electrical appliances in preparing for the evening time. Accordingly, electric power export decreases, which could potentially trigger electric power purchase from the grid. However, upon detecting a transition from the electric power selling state to the electric power buying state, the power conditioner 22 starts discharging the storage battery 21.

The HEMS controller 30, upon acquiring information from the power conditioner 22 that the storage battery 21 has started discharging (“Yes” in step S203), transmits to the switching control unit 105 a signal representative of a permission to supply DC power. The switching control unit 105, in response to receiving this signal, switches the switching unit 103 to a DC power feed (S204). Starting at this moment, the DC electric power stored in the storage battery is fed as is to the air conditioner outdoor unit 11.

As described so far, the HEMS controller 30 is configured to permit a DC power feed only while the storage battery 21 is discharging. Therefore, in a system in which the power conditioner 22 controls the storage battery 21 properly to inhibit boost effect, the HEMS controller 30 may implement control that is simple, but still unfailingly inhibits boost effect, based on whether or not the storage battery 21 is discharging.

No controlling action is made until 23:00 when the first time period starts and the unit price of the electric power stored in the storage battery 21 becomes equal to the unit price of the electric power being bought from the power system grid 25. Because electric power needs to be stored in the storage battery 21 for use in the second and third time periods of a next day, the power conditioner 22 stops discharging the storage battery 21.

Upon detecting that the first time period has started, the HEMS controller 30 transmits to the switching control unit 105 a signal representative of a prohibition of supplying DC power. The switching control unit 105, in response to receiving this signal, switches the switching unit 103 to an AC power feed (S205). Starting at this moment, AC power is fed to the air conditioner outdoor unit 11 from the power system grid 25. The same control is repeated the next day.

By performing the control described above, an air conditioner capable of switchably operating on DC power from the storage battery 21 and AC power from the power system grid 25 may be used in a manner suitable to the electricity tariff system and the excess electric power purchase system.

In addition, since the DC power from the storage battery 21 is used as is to power the apparatus, there may be fewer DC/AC and AC/DC conversions involved. The electric power stored in the storage battery 21 may hence be used more efficiently.

Additionally, if neither the power conditioner 22 nor the electric power monitor has the function of charging/discharging the storage battery 21 by taking into account different electricity tariffs in different time periods, an HEMS controller having that function may be used together to implement control reflecting this while inhibiting boost effect.

### Third Embodiment

The present embodiment has the same basic configuration as the first embodiment. The present embodiment will describe a method of controlling an apparatus control system for a household that has chosen the no-boost effect option in the same tariff system as the one described in the first embodiment.

Note that for convenience of description, members of the present embodiment that have the same function as members of any of the previous embodiments are indicated by the same reference numerals, and description thereof is omitted.

The present embodiment differs from the first embodiment in that the HEMS controller 30 of the present embodiment further acquires information on the remaining capacity of the storage battery 21. The storage battery 21 knows its remaining capacity, and the HEMS controller 30 acquires information on the remaining capacity of the storage battery 21 via the electric power monitor 23.

Furthermore, in the present embodiment, the storage battery 21 is prohibited from discharging to a level below a predetermined fraction of the total capacity thereof in non-blackout periods. This fraction will be referred to as the “preset remaining capacity level.” This is for the purpose of securing electric power that can power the minimum necessary home electrical appliances in case of a power failure in the power system grid 25. The preset remaining capacity level can be set to any value by the user, including 0 and 100%. Attention should be paid however to the fact that if the preset remaining capacity level is set to 0%, the storage battery 21 may be exhausted in a blackout. On the other hand, if the preset remaining capacity level is set to 100%, the storage battery 21 may not be capable of sufficiently powering the air conditioner outdoor unit 11 and like loads in non-blackout periods as described in the present embodiment.

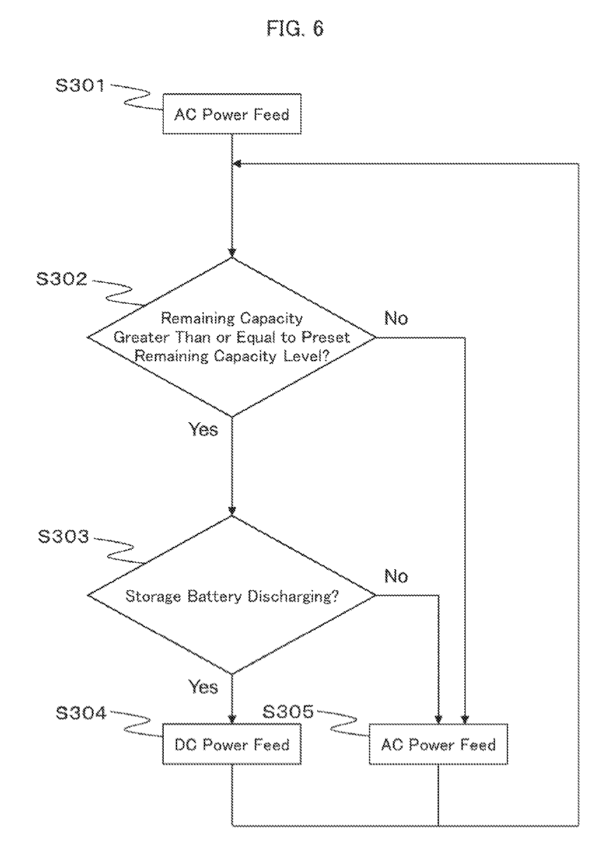

One sunny summer day is taken as a model case, which will be described below in reference to FIGS. 1, 2, and 6. FIG. 6 is a flow chart depicting an operation in accordance with the present embodiment. The air conditioner is continuously switched on in this model case. Charged in the first time period, the storage battery is full at 7:00 in the morning. Assume that the remaining capacity of the storage battery reaches the preset remaining capacity level a little past 20:00.

The HEMS controller 30 regularly acquires information on the remaining capacity of the storage battery 21. From 7:00 to 20:00, the remaining capacity of the storage battery 21 is greater than or equal to the preset remaining capacity level (“Yes” in step S302). Therefore, the air conditioner outdoor unit 11 operates on DC power from the storage battery 21 if the storage battery 21 is discharging and operates on AC power from the power system grid 25 if the storage battery 21 is not discharging, as in the first embodiment.

Upon detecting from the information acquired a little past 20:00 that the remaining capacity of the storage battery 21 has decreased to the preset remaining capacity level (“No” in step S302), the HEMS controller 30 transmits to the switching control unit 105 a signal representative of a prohibition of operating on electric power derived from DC power. The switching control unit 105, in response to receiving this signal, transmits to the switching control unit 105 a signal representative of a prohibition of operating on DC power from the storage battery 21. The switching control unit 105, in response to receiving this signal, switches the switching unit 103 to an AC power feed (S305). Starting at this moment, AC power is fed to the air conditioner outdoor unit 11 from the power system grid 25.

No controlling action is made until 23:00 when the first time period starts and the unit price of the electric power stored in the storage battery 21 becomes equal to the unit price of the electric power being bought from the power system grid 25. Because electric power needs to be stored in the storage battery 21 for use in the second and third time periods of a next day, the power conditioner 22 transmits to the switching control unit 105 a signal representative of a prohibition of operating on DC power from the storage battery 21. Note that since the air conditioner outdoor unit 11 is being already fed with AC power from the power system grid 25 in the present embodiment, no new prohibition signal may be transmitted if there is no need for switching.

This control may enable continuous running of the apparatus on electric power from the power system grid 25 without having to exhaust the electric power stored in the storage battery 21.

### Fourth Embodiment

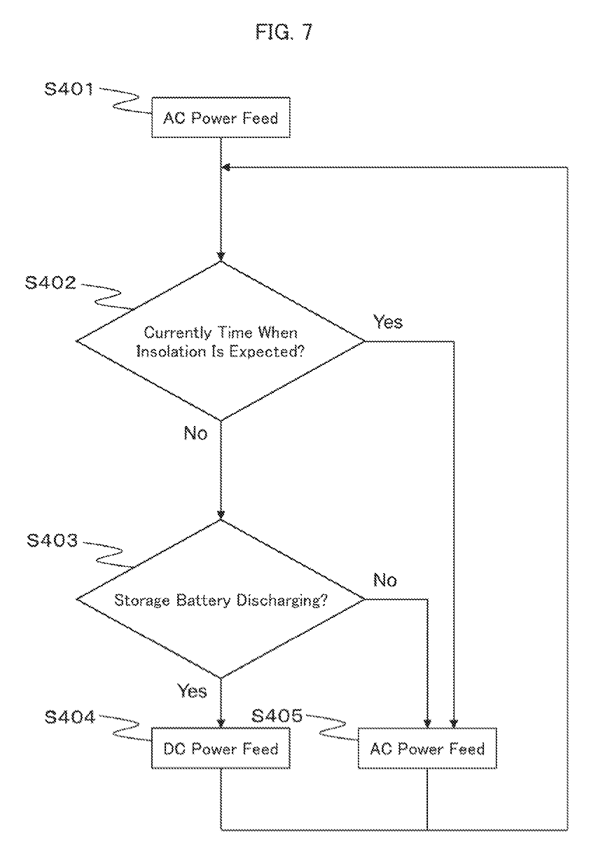

The present embodiment has the same basic configuration as the first embodiment. Referring to FIGS. 1, 2, and 7, the present embodiment will describe a method of controlling an apparatus control system for a household that has chosen the no-boost effect option in the same tariff system as the one described in the first embodiment. FIG. 7 is a flow chart depicting an operation in accordance with the present embodiment.

Note that for convenience of description, members of the present embodiment that have the same function as members of any of the previous embodiments are indicated by the same reference numerals, and description thereof is omitted.

The present embodiment differs from the first embodiment in that the HEMS controller 30 of the present embodiment acquires sunrise and sunset information to, when insolation is expected, prohibit the air conditioner outdoor unit 11 from operating on DC power. To put it differently, the air conditioner outdoor unit 11 operates on DC power if the storage battery 21 is discharging when no insolation is expected.

The control in accordance with the first embodiment alone may allow for boost effect in a system or situation where it takes time for the HEMS controller 30 to acquire information indicating that the storage battery 21 has stopped discharging, and based on this acquired information, transmit to the switching control unit 105 a signal representative of a prohibition of a DC power feed.

The configuration of the present embodiment however prohibits the air conditioner outdoor unit 11 from operating on DC power whenever there is such insolation in the first place that the solar cells 20 can generate electric power. The present embodiment may therefore enable control that more reliably prevents boost effect.

Specifically, the HEMS controller 30 acquires information related to sunrise and sunset times from the server 33 and, at a time when insolation is expected (“Yes” in step S402), prohibits the air conditioner outdoor unit 11 from operating on DC power (S405). To put it differently, the HEMS controller 30 transmits to the switching control unit 105 a signal representative of a permission to feed DC power if it is a time when the solar cells 20 are not expected to generate electric power (“No” in step S402) and the storage battery 21 is discharging (“Yes” in step S403). The switching control unit 105, in response to receiving this signal, switches the switching unit 103 to a DC power feed (S404).

Instead of acquiring sunrise and sunset time information, the HEMS controller 30 may acquire or contain information on the relationship between the calendar and times when insolation is expected so as to prohibit the air conditioner outdoor unit 11 from operating on DC power when insolation is expected.

As another alternative, the HEMS controller 30 may acquire the day's weather information in association with sunrise and sunset time information to perform the control described above using these pieces of information. In such a case, for example, if it is likely that there will be no electric power to sell because it is rainy and the solar cells 20 are not generating much electric power, the HEMS controller 30 may permit the air conditioner outdoor unit 11 to operate on a DC power feed anytime from sunrise to sunset.

Since the control in the present embodiment is based on time (time of day) information, the apparatus control system of the present embodiment needs to maintain accurate time information. Take, as an example, a case where the HEMS controller 30 has a clock that is running 1 hour ahead of time, recognizes the sunset on the basis of that clock, and accordingly permits the air conditioner outdoor unit 11 to operate on a DC power feed. Since the actual sunset time is 1 hour later, there is still insolation and the solar cells 20 are generating electric power, which could lead to boost effect depending on the balance between electric power generation and consumption. To avoid such a situation from happening, the HEMS controller 30 acquires an accurate time from an “NTP” (network time protocol) server and does not permit the air conditioner outdoor unit 11 to operate on a DC power feed unless the HEMS controller 30 acquires an accurate time from an NTP server. Furthermore, the apparatus control system may allow the clock thereof to be adjusted based only on the information acquired from an NTP, not on an input from the user.

### Fifth Embodiment

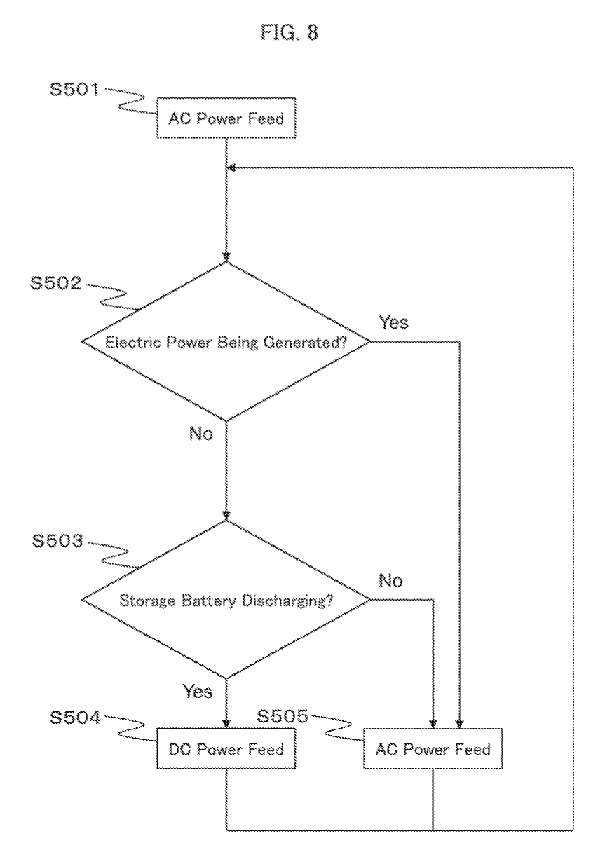

The present embodiment has the same basic configuration as the first embodiment. Referring to FIGS. 1, 2, and 8, the present embodiment will describe a method of controlling an apparatus control system for a household that has chosen the no-boost effect option in the same tariff system as the one described in the first embodiment. FIG. 8 is a flow chart depicting an operation in accordance with the present embodiment.

Note that for convenience of description, members of the present embodiment that have the same function as members of any of the previous embodiments are indicated by the same reference numerals, and description thereof is omitted.

The present embodiment differs from the first embodiment in that the HEMS controller 30 of the present embodiment acquires information on the generation of power by the solar cells 20 from the power conditioner 22 and when the solar cells 20 are generating electric power, prohibits the air conditioner outdoor unit 11 from operating on DC power. This configuration may enable control that more reliably prevents boost effect than in the first to fourth embodiments.

The HEMS controller 30 acquires information related to the electric power generation by the solar cells 20 from the power conditioner 22 and if the solar cells 20 are generating electric power (“Yes” in step S502), prohibits the air conditioner outdoor unit 11 from operating on DC power (S505). To put it differently, the HEMS controller 30 transmits to the switching control unit 105 a signal representative of a permission to feed DC power if the solar cells 20 are not generating electric power (“No” in step S502) and the storage battery 21 is discharging (“Yes” in step S503). The switching control unit 105, in response to receiving this signal, switches the switching unit 103 to a DC power feed (S504).

The information on the generation of power by the solar cells 20 may be, for example, input power and voltage of the power conditioner 22 (output power and voltage of the solar cells 20) or information related to the output power.

At daybreak, insolation could abruptly increase from darkness to a level where there occurs an output from the solar cells 20. Accordingly, the HEMS controller 30 may prohibit the air conditioner outdoor unit 11 from operating on DC power well before insolation reaches a level where there occurs an output from the solar cells 20, which will more reliably inhibit boost effect. It will be appreciated that to this end, the control may be based on an acquired sunrise time as described in the fourth embodiment as well as on the information on the generation of power by the solar cells 20.

In contrast, in the early evening, insolation is unlikely to increase again. Therefore, if insolation becomes stable at a level lower than a level where there occurs an output from the solar cells 20, the HEMS controller 30 may determine that the electric power generation by the solar cells 20 will not result in boost effect after that time and permit the air conditioner outdoor unit 11 to operate on DC power.

This configuration prevents boost effect where the air conditioner outdoor unit 11 operates from the storage battery 21 while the solar-generated electric power is being sold.

If the power consumption of the household is highly likely to reach a certain minimum level or increase beyond that, the DC power feed may be prohibited if the electric power generation by the solar cells 20 is greater than or equal to this minimum level.

In addition, to monitor the actual amount of electric power generated by the solar cells 20 to utilize the monitored amount in the control, the HEMS controller 30 may permit the air conditioner outdoor unit 11 to operate on a DC power feed if the solar cells 20 are generating no or little electric power due to, for example, rain during the daytime, and electric power will be continuously bought regardless of variations in the generation and consumption of electric power. The power conditioner 22 initially has a function of monitoring power generation. This operation may therefore be implemented by suitably modifying the control method without introducing new equipment.

In the first to fifth embodiments, the switching control unit 105 may determine whether electric power is being sold to, or bought from, the power system grid 25 either instead of or in addition to determining whether or not the storage battery 21 is discharging, to accordingly switch the switching unit 103. This arrangement may also be capable of efficiently using an apparatus operating on both DC power stored in the storage battery 21 and AC power.

### Sixth Embodiment

The present embodiment differs from the first embodiment in that the present embodiment includes no HEMS controller 30. Referring to FIGS. 1, 2, 9, and 10, the present embodiment will describe a method of controlling an apparatus control system for a household that has chosen the no-boost effect option in the same tariff system as the one described in the first embodiment.

Note that for convenience of description, members of the present embodiment that have the same function as members of any of the previous embodiments are indicated by the same reference numerals, and description thereof is omitted.

### System Configuration

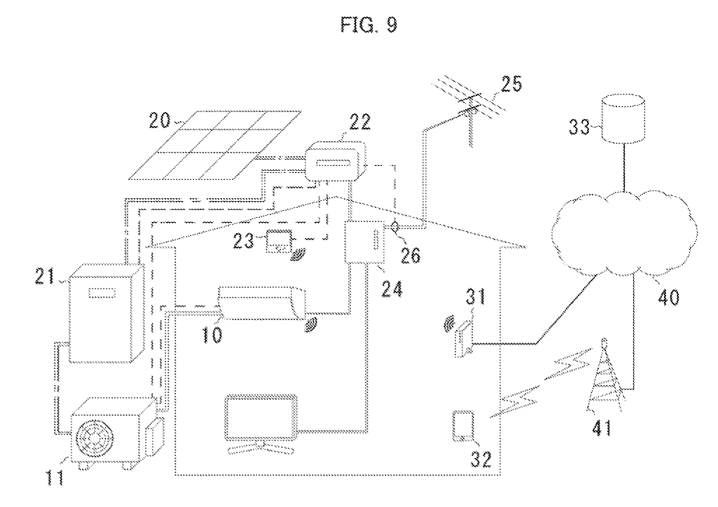

FIG. 9 is a schematic illustration of an apparatus control system in accordance with the sixth embodiment.

The apparatus control system shown in FIG. 9 includes home electrical appliances, a power conditioner 22, an electric power monitor 23, and a router 31. The home electrical appliances include among others an air conditioner indoor unit 10, an air conditioner outdoor unit 11, and a television. The power conditioner 22 is connected to a storage battery 21. The electric power monitor 23 may acquire information from the power conditioner 22 to produce a display.

In the present embodiment, the server 33 has a function of receiving and storing information on electric power and cumulative electric power that is transmitted from the electric power monitor 23.

In addition, in the present embodiment, the switching control unit 105 is disposed inside the air conditioner outdoor unit 11 shown in FIG. 9 and configured to receive control signals from the power conditioner 22 via wired communications and to transmit switching control signals to the switching unit 103 in the air conditioner outdoor unit 11 in response to these control signals.

### How to Control the System

The present embodiment will now describe a method of controlling an apparatus control system for a household that has chosen the no-boost effect option in the same tariff system as the one described in the first embodiment.

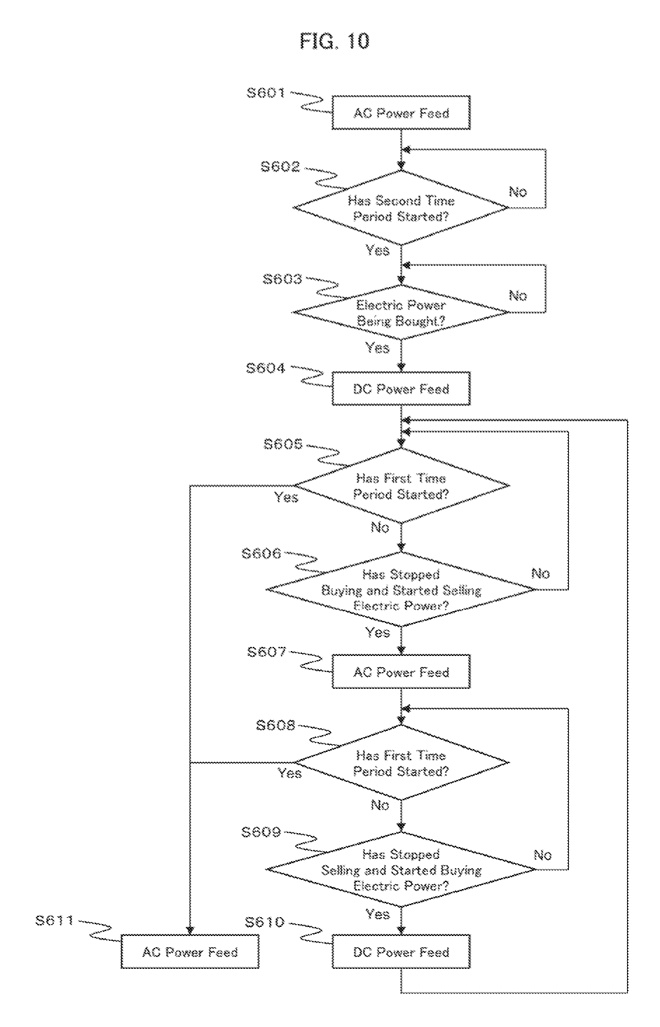

One sunny summer day is taken as a model case, which will be described below in reference to FIGS. 2, 9, and 10. The air conditioner is continuously switched on in this model case. FIG. 10 is a flow chart depicting an operation of the apparatus control system in accordance with the present embodiment.

The air conditioner outdoor unit 11 is operating on AC in the first time period (S601).

Charged in the first time period, the storage battery 21 is full at 7:00 in the morning. Assume that the storage battery 21 has a sufficient capacity to supply the electric power required in the present embodiment. At 7:00 when the first time period ends and the second time period starts, the unit electricity price rises. The air conditioner is therefore operated at a lower unit electricity price if it is powered by the storage battery 21 than by the power system grid 25. Hence, when the first time period ends and the second time period starts (S602), the electric power monitor 23 transmits to the switching control unit 105 a signal representative of a permission to supply DC power. The switching control unit 105, in response to receiving this signal, switches the switching unit 103 to a DC power feed (S604). Starting at this moment, the DC electric power stored in the storage battery 21 is fed as is to the air conditioner outdoor unit 11.

Note that the electric power monitor 23 checks, before the switching, whether or not electric power is being bought from the power system grid 25 (S603). Upon determining that electric power is being bought from the power system grid 25, the electric power monitor 23 permits the switching.

No controlling action is made until 9:00 when the solar cells 20 generate more electric power in accordance with increasing insolation whereas power consumption decreases because the family uses less of the home electrical appliances in preparing themselves for the day. Accordingly, the household buys less electric power from the grid, and excess electric power is generated, a situation that could potentially lead to electric power export. However, immediately upon detecting a start of power export, that is, a transition from the electric power buying state to the electric power selling state (S606), the power conditioner 22 transmits a signal representative of this detection to the switching control unit 105.

The switching control unit 105, in response to receiving this signal, immediately switches the switching unit 103 to an AC power feed (S607).

Starting at this moment, AC power is fed to the air conditioner outdoor unit 11 from the power system grid 25. This control is performed for the purpose of inhibiting boost effect. The switching unit 103 is switched to an AC power feed based particularly on a signal from the power conditioner 22. Response time may therefore be cut short, which could lead to more reliable export inhibition.

The switching unit 103 may be switched not immediately before the transition from the electric power buying state to the electric power selling state, but when the electric power being bought has decreased to or below a predetermined level, to inhibit boost effect.

No controlling action is made until 16:00 when the solar cells 20 generate less electric power in accordance with decreasing insolation whereas power consumption increases because the family uses more of the home electrical appliances in preparing for the evening time. Accordingly, electric power export decreases, which could potentially trigger electric power purchase from the grid. However, upon detecting a transition from the electric power selling state to the electric power buying state (S609), the power conditioner 22 transmits to the switching control unit 105 a signal representative of a permission to supply DC power. The switching control unit 105, in response to receiving this signal, switches the switching unit 103 to a DC power feed (S610). Starting at this moment, the DC electric power stored in the storage battery 21 is fed as is to the air conditioner outdoor unit 11. The switching unit 103 may be switched not immediately after a transition from the electric power selling state to the electric power buying state, but when the electric power being bought has increased to or above a predetermined level or when at least a predetermined period of time has elapsed after a transition from the electric power selling state to the electric power buying state, to inhibit boost effect.

This predetermined level of electric power being bought may be a maximum AC power consumption of the air conditioner outdoor unit 11.

With these specifications, no transition from the electric power buying state to the electric power selling state will occur following a termination of AC electric power purchase covering consumption by the air conditioner outdoor unit 11.

Assume the following specifications in the system of the present embodiment: there is a lower upper limit on DC power consumption than on AC power consumption, and an AC power feed is replaced by a DC power feed when power consumption has decreased to or below this upper limit. In such a case, the predetermined level of electric power being bought may be a maximum power consumption at which the air conditioner outdoor unit 11 can be switched from an AC power feed to a DC power feed, that is, a maximum DC power consumption of the air conditioner outdoor unit 11.

With these specifications, no transition from the electric power buying state to the electric power selling state will occur following a termination of AC electric power purchase covering consumption by the air conditioner outdoor unit 11.

It will be appreciated that the switching unit 103 may be switched when at least a predetermined period of time has elapsed from a moment at which at least this predetermined level is reached or exceeded

No controlling action is made until 23:00 when the first time period starts (S605, S608) and the unit price of the electric power stored in the storage battery 21 becomes equal to the unit price of the electric power being bought from the power system grid 25. Because electric power needs to be stored in the storage battery 21 for use in the second and third time periods of a next day, the electric power monitor 23 transmits to the switching control unit 105 a signal representative of a prohibition of operating on DC power from the storage battery 21. The switching control unit 105, in response to receiving this signal, switches the switching unit 103 to an AC power feed (S611). Starting at this moment, AC power is fed to the air conditioner outdoor unit 11 from the power system grid 25.

The same control is repeated the next day.

Step 605 (S605) to step 611 (S611) shown in FIG. 10 may, even if a transition occurs from the electric power buying state to the electric power selling state or vice versa due to variations in electric power generation by the solar cells 20 or variations in the power consumption of loads in the house after a second time period ends, but before a next first time period starts, enable switching of the electric power feed to the air conditioner outdoor unit 11 between DC power and AC power in accordance with such a transition.

By performing the control described above, an air conditioner capable of switchably operating on DC power from the storage battery 21 and AC power from the power system grid 25 may be used in a manner suitable to the electricity tariff system and the excess electric power purchase system.

In addition, since the DC power from the storage battery 21 is used as is to power the apparatus, there may be fewer DC/AC and AC/DC conversions involved. The electric power stored in the storage battery 21 may hence be used more efficiently.

The present embodiment uses a function of the power conditioner 22 to determine whether electric power is being bought or sold. It will be appreciated that another measuring instrument may be used from which the switching control unit 105 directly obtains results of the determination. In any case, it is only required that power export (reverse power flow) be detected at a power receiving point to immediately switch the electric power feed to the air conditioner outdoor unit 11 between DC power and AC power.

In the present embodiment, the electric power monitor 23 has been described as playing a central role in the above-described control. The server 33 may play a central role in the control except for the detection of export.

In accordance with aspect 3 of the present invention, the apparatus control device of aspect 1 may be such that the DC power source is connected to a solar power generation device, wherein the controller is configured to determine whether electric power is being sold to, or bought from, the power system grid either instead of or in addition to determining whether or not the DC power source is discharging and accordingly switch the switching circuit.

According to this arrangement, it is determined whether electric power is being sold to, or bought from, the power system grid, and the switching circuit is accordingly switched. The arrangement may hence more reliably reduce chances of boost effect.

### Seventh Embodiment

The present embodiment has the same basic configuration as the sixth embodiment. The present embodiment will describe a method of controlling an apparatus control system for a household that has chosen the no-boost effect option in the same tariff system as the one described in the sixth embodiment.

Note that for convenience of description, members of the present embodiment that have the same function as members of any of the previous embodiments are indicated by the same reference numerals, and description thereof is omitted.

The present embodiment differs from the sixth embodiment in that the electric power monitor 23 of the present embodiment utilizes information on the remaining capacity of the storage battery 21, as well as information as to whether electric power is being sold or bought, in performing the control. The storage battery 21 knows its remaining capacity, and the electric power monitor 23 acquires information on the remaining capacity of the storage battery 21.

Furthermore, in the present embodiment, the storage battery 21 is prohibited from discharging to a level below a predetermined fraction of the total capacity thereof in non-blackout periods. This fraction will be referred to as the “preset remaining capacity level.” This is for the purpose of securing electric power that can power the minimum necessary home electrical appliances in case of a power failure in the power system grid 25. The preset remaining capacity level can be set to any value by the user, including 0 and 100%. Attention should be paid however to the fact that if the preset remaining capacity level is set to 0%, the storage battery 21 may be exhausted in a blackout. On the other hand, if the preset remaining capacity level is set to 100%, the storage battery 21 may not be capable of sufficiently powering the air conditioner outdoor unit 11 and like loads in non-blackout periods as described in the present embodiment.

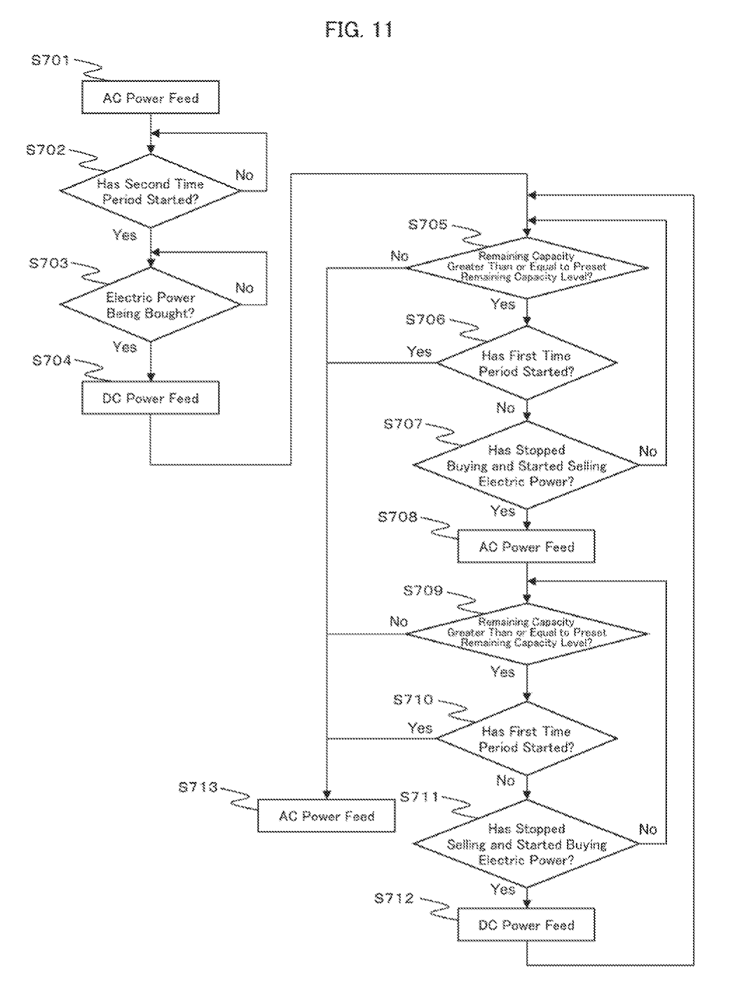

One sunny summer day is taken as a model case, which will be described below in reference to FIGS. 2, 9, and 11. The air conditioner is continuously switched on in this model case. Charged in the first time period, the storage battery 21 is full at 7:00 in the morning. Assume that the remaining capacity of the storage battery 21 reaches the preset remaining capacity level a little past 20:00.

The apparatus control system operates in the same manner as in the sixth embodiment up to 20:00, and description thereof is omitted. The air conditioner outdoor unit 11 is operating on DC power from the storage battery 21 at 20:00.

The electric power monitor 23 regularly acquires information on the remaining capacity of the storage battery 21 (S705, S709). Upon detecting from the information acquired a little past 20:00 that the remaining capacity of the storage battery 21 has decreased to the preset remaining capacity level, the electric power monitor 23 transmits to the switching control unit 105 a signal representative of a prohibition of operating on electric power derived from DC power. The switching control unit 105, in response to receiving this signal, transmits to the switching control unit 105 a signal representative of a prohibition of operating on DC power from the storage battery 21. The switching control unit 105, in response to receiving this signal, switches the switching unit 103 to an AC power feed (S713). Starting at this moment, AC power is fed to the air conditioner outdoor unit 11 from the power system grid 25.

No controlling action is made until 23:00 when the first time period starts and the unit price of the electric power stored in the storage battery 21 becomes equal to the unit price of the electric power being bought from the power system grid 25. Because electric power needs to be stored in the storage battery 21 for use in the second and third time periods of a next day, the electric power monitor 23 transmits to the switching control unit 105 a signal representative of a prohibition of operating on DC power from the storage battery 21. Note that since the air conditioner outdoor unit 11 is being already fed with AC power from the power system grid 25 in the present embodiment, no new prohibition signal may be transmitted if there is no need for switching.

This control may enable continuous running of the apparatus on electric power from the power system grid 25 without having to exhaust the electric power stored in the storage battery 21.

### Eighth Embodiment

The present embodiment has the same basic configuration as the sixth embodiment. The present embodiment differs from the sixth embodiment in that the electric power monitor 23 of the present embodiment acquires weather forecast information which will be used in the control.

Note that for convenience of description, members of the present embodiment that have the same function as members of any of the previous embodiments are indicated by the same reference numerals, and description thereof is omitted.

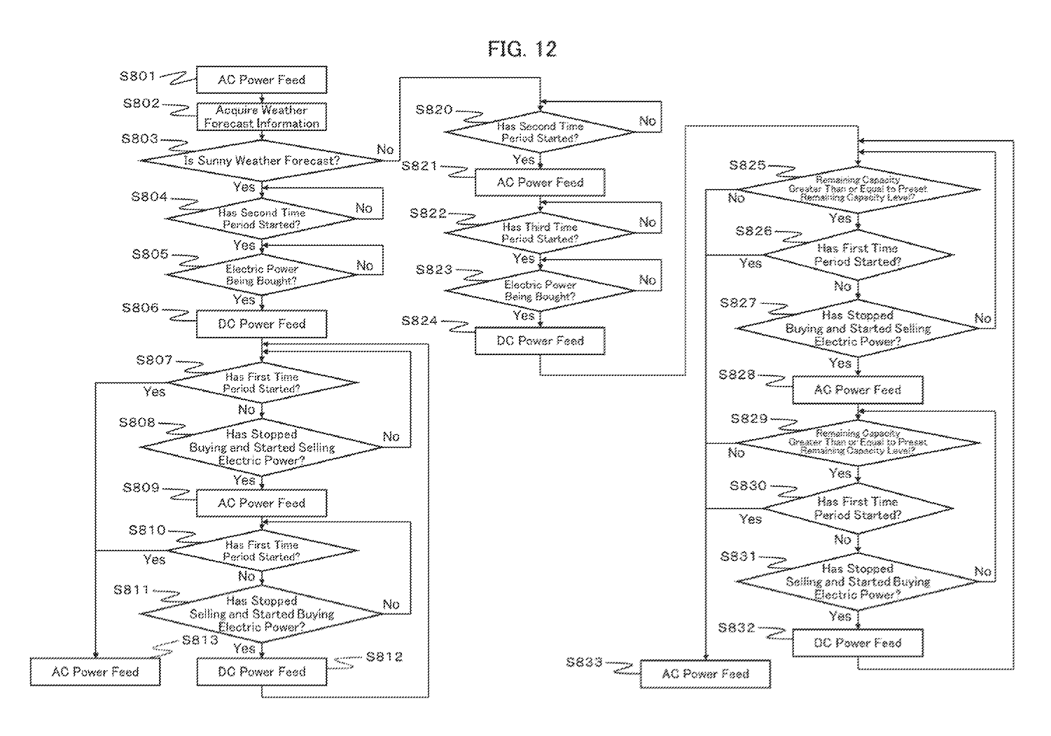

A description will be given below in reference to FIG. 12. Assume that the electric power monitor 23 has already acquired today's weather forecast information by accessing the server 33 via the router 31 (S802).

Charged in the first time period, the storage battery 21 is full at 7:00 in the morning. Assume that the storage battery 21 however does not have a sufficient charged capacity to cover all the power consumption of electric apparatus throughout the second and third time periods.

If the weather forecast says that it will be a sunny day, the present embodiment is no different from the sixth embodiment. The following description will focus on cases where the weather forecast says that it will be rainy (“No” in step S803).

At 7:00 when the first time period ends and the second time period starts (S820), the unit electricity price rises. The air conditioner is therefore operated at a lower unit electricity price if it is powered by the storage battery 21 than by the power system grid 25.

However, the electric power monitor 23, having acquired a forecast that today's weather will be rainy, transmits to the switching control unit 105 a signal representative of a prohibition of supplying DC power from the storage battery 21. The switching control unit 105, in response to receiving this signal, switches the switching unit 103 to an AC power feed (S821). Starting at this moment, AC power is fed to the air conditioner outdoor unit 11 from the power system grid 25. Note that since electric power is fed from the power system grid 25 also in the first time period, the electric power monitor 23 may determine that the electric power feed does not need to be changed and transmit no control signal.

If today's weather forecast is correct and it actually rains in this situation, no solar power generation is expected during the daytime. If the electric power stored in the storage battery 21 starts to be used in the second time period which starts at 7:00 and is exhausted in the third time period, electric power needs to be bought from the power system grid 25 in the third time period. This is because electric power is available at a lower unit electricity price if it is bought in the second time period than in the third time period.

No controlling action is made until 10:00 (S822) when the electric power monitor 23 transmits to the switching control unit 105 a signal representative of a permission to supply DC power. The switching control unit 105, in response to receiving this signal, switches the switching unit 103 to a DC power feed (S824). Starting at this moment, the DC electric power stored in the storage battery 21 is fed as is to the air conditioner outdoor unit 11.

Note that the electric power monitor 23 checks, before the switching, whether electric power is actually being bought (S823). Upon determining that electric power is being bought, the electric power monitor 23 implements the switching.

There are cases where despite a rainy forecast, the real weather is such that there is insolation and the solar cells 20 generate electric power. Therefore, the present embodiment may be arranged so as to switch between a DC power feed and an AC power feed in accordance with the electric power buying and selling states as in the sixth embodiment and to check information on the remaining capacity of the storage battery 21 as in the seventh embodiment (S825 to S832).

No controlling action is made until 23:00 when the first time period starts and the unit price of the electric power stored in the storage battery 21 becomes equal to the unit price of the electric power being bought from the power system grid 25. Because electric power needs to be stored in the storage battery 21 for use in the second and third time periods of a next day, the electric power monitor 23 transmits to the switching control unit 105 a signal representative of a prohibition of supplying DC power from the storage battery 21 (S826, S830). The switching control unit 105, in response to receiving this signal, switches the switching unit 103 to an AC power feed (S833). Starting at this moment, AC power is fed to the air conditioner outdoor unit 11 from the power system grid 25.

In the present embodiment, the electric power monitor 23 acquires weather forecast information. Alternatively, an HEMS (home energy management system) controller (not shown) or like device that performs energy monitoring for a house in which the device is installed may be used in place of an electric power monitor to acquire information which will be used in the control.

The embodiments disclosed herein are for illustrative purposes only. Specific arrangements should by no means limited to these embodiments. The embodiments may be combined or modified in a suitable manner.

The storage battery 21 has been used as a DC power source to describe the present embodiment. Alternatively, any other DC power source such as fuel cells may be used.

To describe the present embodiment, the air conditioner outdoor unit has been used as an example of an apparatus that switchably operates on DC power from the storage battery 21 and AC power from a power system grid. Alternatively, another apparatus such as a refrigerator may be used.

In addition, in the sixth to eighth embodiments, the switching control unit 105 may determine whether or not the storage battery 21 is discharging, either instead of or in addition to determining whether electric power is being bought from, or sold to, the power system grid 25, and accordingly switch the switching unit 103. This arrangement may also be capable of efficiently using an apparatus operating on both DC power stored in the storage battery 21 and AC power.

### Summation

The present invention, in aspect 1 thereof, is directed to an apparatus control device including: a switching circuit (switching unit 103) disposed inside or outside an electric apparatus operating on DC power fed from a DC power source (storage battery 21) and AC power fed from an AC power source including a power system grid (power system grid 25), the switching circuit being configured to switch a power feed to the electric apparatus between the DC power and the AC power; and a controller (switching control unit 105) configured to determine whether or not the DC power source is discharging and accordingly switch the switching circuit.

According to this implementation, the apparatus control device switches a power feed to the electric apparatus between DC power and AC power on the basis of whether the DC power source is discharging. Therefore, the resultant apparatus control device may be capable of efficiently using an apparatus operating on both AC power and DC power stored in a storage battery.

In aspect 2 of the present invention, the apparatus control device of aspect 1 may be arranged such that the controller is configured to control the switching circuit so as to supply the DC power to the electric apparatus when the DC power source is discharging.

According to this implementation, the switching circuit is controlled to supply DC power to the electric apparatus when the DC power source is discharging. Therefore, chances of boost effect may be reduced.

In aspect 3 of the present invention, the apparatus control device of aspect 1 may be arranged such that the DC power source is connected to a solar power generation device, wherein the controller is configured to determine whether electric power is being sold to, or bought from, the power system grid either instead of or in addition to determining whether or not the DC power source is discharging and accordingly switch the switching circuit.

According to this implementation, the apparatus control device switches a power feed to the electric apparatus between DC power and AC power on the basis of whether electric power is being sold to, or bought from, the power system grid. Therefore, an apparatus operating on both AC power and DC power stored in a storage battery may be efficiently used.

In aspect 4 of the present invention, the apparatus control device of aspect 3 may be arranged such that the controller is configured to control the switching circuit so as to supply the AC power to the electric apparatus when electric power being bought from the power system grid has decreased to or below a predetermined level.

According to this implementation, the switching circuit is controlled to supply AC power to the electric apparatus when the electric power being bought from the power system grid has decreased to or below a predetermined level. Therefore, chances of boost effect may be more reliably reduced.

In aspect 5 of the present invention, the apparatus control device of any one of aspects 1 to 4 may be arranged such that the controller is configured to control the switching circuit based on time of day.

According to this implementation, the switching circuit may be controlled, for example, in accordance with a time period when there is generated much electric power or a time period when electric power is bought from the power system grid at a different unit electricity price.

In aspect 6 of the present invention, the apparatus control device of aspect 5 may be arranged such that the controller is configured to control the switching circuit in accordance with time periods for which different unit prices are specified for electric power bought from the power system grid.

According to this implementation, it may be possible to perform such control, for example, as to store electric power in a DC power source in a time period when the unit electricity price is low and consume the electric power stored in the DC power source in a time period when the unit electricity price is high. The user may therefore enjoy economic benefits.

In aspect 7 of the present invention, the apparatus control device of any one of aspects 1 to 4 may be arranged such that the controller is configured to control the switching circuit based on a remaining capacity of a storage battery serving as the DC power source.

According to this implementation, it may be possible to operate the electric apparatus on electric power from the AC power source without having to exhaust the electric power stored in the storage battery.

In aspect 8 of the present invention, the apparatus control device of any one of aspects 1 to 4 may be arranged such that the controller is configured to control the switching circuit based on weather forecast information.

According to this implementation, the consumption of the electric power stored in the DC power source may be regulated on the basis of weather forecast. Therefore, the charged capacity of the DC power source may be controlled in a suitable manner.

The present invention, in aspect 9 thereof, is directed to an apparatus control system including: the apparatus control device of any one of aspects 1 to 8: a solar power generation device; a DC power source connected to the solar power generation device; and an electric apparatus operating on DC power fed from the DC power source and AC power fed from an AC power source including a power system grid.

According to this implementation, the resultant apparatus control system may be capable of efficiently using an apparatus operating on both AC power and DC power stored in a storage battery.

The present invention, in aspect 10 thereof, is directed to an apparatus control method of operating a switching circuit disposed inside or outside an electric apparatus operating on DC power fed from a DC power source and AC power fed from an AC power source including a power system grid, the switching circuit being configured to switch a power feed to the electric apparatus between the DC power and the AC power, the method including: determining whether or not the DC power source is discharging; and accordingly switching the switching circuit.

The resultant apparatus control method may be capable of efficiently using an apparatus operating on both AC power and DC power stored in a storage battery.

### Additional Description

The present invention may be described in the following manner. An apparatus control system in accordance with the present invention includes: a DC power source; a home electrical appliance receiving and operating on electric power from the DC power source DC/DC connected to the home electrical appliance and electric power from a power system grid; a switching unit disposed inside or outside the home electrical appliance, the switching unit being configured to switch a power feed to the home electrical appliance between the electric power from the DC power source and electric power from an AC power network; and a control unit configured to control switching of the switching unit based on whether or not the DC power source is discharging.

The apparatus control system in accordance with the present invention may be arranged to switch the switching unit such that the home electrical appliance operates on the electric power from the DC power source when the DC power source is discharging.

The apparatus control system in accordance with the present invention may be arranged such that the control unit is configured to control the switching unit based on a remaining capacity of a storage battery serving as the DC power source.

A control method in accordance with the present invention is implemented by a control unit configured to control a switching unit disposed inside or outside a home electrical appliance receiving and operating on electric power from a DC power source DC/DC connected to the home electrical appliance and electric power from a power system grid, the switching unit being configured to switch a power feed to the home electrical appliance between the electric power from the DC power source and electric power from an AC power network, the method including controlling the switching unit based on whether or not the DC power source is discharging.

Another apparatus control system in accordance with the present invention includes: a DC power source; a solar power generation device; an electric apparatus receiving and operating on electric power from the DC power source DC/DC connected to the electric apparatus and electric power from a power system grid; a switching unit disposed inside or outside the electric apparatus, the switching unit being configured to switch a power feed to the electric apparatus between the electric power from the DC power source and electric power from an AC power network; and a control unit configured to determine, from information acquired from the solar power generation device, whether the apparatus control system is buying or selling electric power to the power system grid and accordingly switch the switching unit.

The apparatus control system in accordance with the present invention may be arranged such that the control unit is configured to control the switching unit based on time of day.

The apparatus control system in accordance with the present invention may be arranged such that the control unit is configured to control the switching unit based on a remaining capacity of a storage battery serving as the DC power source.

The apparatus control system in accordance with the present invention may be arranged such that the control unit is configured to control the switching unit based on weather forecast information.

Another control method in accordance with the present invention is implemented by a control unit configured to control a switching unit disposed inside or outside an electric apparatus receiving and operating on electric power from a DC power source DC/DC connected to the electric apparatus and electric power from a power system grid, the switching unit being configured to switch a power feed to the electric apparatus between the electric power from the DC power source and electric power from an AC power network, the method including: acquiring from the solar power generation device information indicating whether an apparatus control system including the electric apparatus and a storage battery is buying or selling electric power to the power system grid; and controlling the switching unit based on this acquired information.

### REFERENCE SIGNS LIST

10, 101 Air Conditioner Indoor Unit (Air Conditioner)
11 Air Conditioner Outdoor Unit (Air Conditioner/Electric Apparatus)
20 Solar Cells (Solar Power Generation Device)
21 Storage Battery (DC Power Source)
22 Power Conditioner (Solar Power Generation Device)
23 Electric Power Monitor
24 Power Distribution Board
25 Power System Grid (AC Power Source)
30 HEMS Controller
31 Router
32 Mobile Terminal
33 Server
40 Internet
41 Public Telephone Network
103 Switching Unit (Switching Circuit)
105 Switching Control Unit (Controller)

1. An apparatus control device comprising:
a switching circuit disposed inside or outside an electric apparatus operating on DC power fed from a DC power source and AC power fed from an AC power source comprising a power system grid, the switching circuit being configured to switch a power feed to the electric apparatus between the DC power and the AC power; and
a controller configured to determine whether or not the DC power source is discharging and accordingly switch the switching circuit.

2. The apparatus control device according to claim 1, wherein the controller is configured to control the switching circuit so as to supply the DC power to the electric apparatus when the DC power source is discharging.

3. The apparatus control device according to claim 1, the DC power source being connected to a solar power generation device, wherein the controller is configured to determine whether electric power is being sold to, or bought from, the power system grid either instead of or in addition to determining whether or not the DC power source is discharging and accordingly switch the switching circuit.

4. The apparatus control device according to claim 3, wherein the controller is configured to control the switching circuit so as to supply the AC power to the electric apparatus when electric power being bought from the power system grid has decreased to or below a predetermined level.

5. The apparatus control device according to claim 1, wherein the controller is configured to control the switching circuit based on time of day.

6. The apparatus control device according to claim 5, wherein the controller is configured to control the switching circuit in accordance with time periods for which different unit prices are specified for electric power bought from the power system grid.

7. The apparatus control device according to claim 1, wherein the controller is configured to control the switching circuit based on a remaining capacity of a storage battery serving as the DC power source.

8. The apparatus control device according to claim 1, wherein the controller is configured to control the switching circuit based on weather forecast information.

9. An apparatus control system comprising:
the apparatus control device according to claim 1;
a solar power generation device;
a DC power source connected to the solar power generation device; and
an electric apparatus operating on DC power fed from the DC power source and AC power fed from an AC power source comprising a power system grid.

10. An apparatus control method of operating a switching circuit disposed inside or outside an electric apparatus operating on DC power fed from a DC power source and AC power fed from an AC power source comprising a power system grid, the switching circuit being configured to switch a power feed to the electric apparatus between the DC power and the AC power, said method comprising:
determining whether or not the DC power source is discharging; and
accordingly switching the switching circuit.
